(19) United States
(12) Patent Application Publication
(10) Pub. No.: US 2008/0143125 A1
(43) Pub. Date: Jun. 19, 2008

(54) STEP BUMPER WITH TOW HITCH

(75) Inventors: Rainer B. Nees, West Olive, MI (US); Edward C. Pendergrass, Zeeland, MI (US); Daniel W. Gatti, Grand Haven, MI (US); Aimee N. Cohoon, Grand Haven, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Shape Corporation

(21) Appl. No.: 11/842,773

(22) Filed: Aug. 21, 2007

Related U.S. Application Data
(60) Provisional application No. 60/869,837, filed on Dec. 13, 2006.

(51) Int. Cl. B60R 19/02; B60D 1/00

(52) U.S. Cl. 293/117; 293/102

(57) ABSTRACT

A bumper system includes a rectangular tubular beam made of high strength material. A center section of the beam is deformed downward and rearward so that a hitch tube receiver welded to a bottom of the center section is secured at a lowered and rearward position relative to the vehicle. At the same time, the ends of the beam are maintained in alignment and in a higher/forward position to support fascia and in particular to support step-forming portions of the fascia on ends of the bumper system.

This application claims benefit under 35 U.S.C. § 119(e) of provisional application Ser. No. 60/869,837, filed Dec. 13, 2006, entitled STEP BUMPER WITH TOW HITCH, the entire contents of which are incorporated herein in their entirety.

### BACKGROUND

The present invention relates to step bumper systems with a tow hitch.

Bumpers are often used for towing. However, the structure for supporting the hitch preferably requires a minimum number of components, weighs a minimum amount, and fits within an acceptable package size to underlie an aesthetically acceptable assembly. These conflicting requirements are often not easily met.

Thus, a system having the aforementioned advantages and solving the aforementioned problems is desired.

### SUMMARY OF THE PRESENT INVENTION

In one aspect of the present invention, a bumper system includes a tubular beam having a linear center section, opposing linear end sections, and compound-bent transition sections connecting the end sections to ends of the center section; the center section extending parallel the end sections but being positioned rearward and lower than the end sections when in a vehicle-mounted position by the transition sections.

In another aspect of the present invention, a bumper system includes a rectangular tubular beam having a continuous cross-sectional shape and having a center section, opposing end sections, and transition sections connecting the end sections to ends of the center section. The transition sections are bent both vertically and horizontally to position the center section both rearward and downward from the end sections when in a vehicle-mounted position.

In still another aspect of the present invention, a bumper system includes a rectangular tubular beam having a continuous cross-sectional shape and having a center section and opposing end sections, the center section being positioned both rearward and downward from the end sections when in a vehicle-mounted position. A hitch receiver is attached to a bottom of the center section, and a fascia covers the tubular beam and includes end panels supported by the end sections to form steps on the bumper system.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of the present bumper system, and FIG. 1A is a similar view but showing a fascia on the bumper system.

FIGS. 2-6 are top, front, bottom, rear, and end views of the bumper system of FIG. 1.

FIG. 7 is a cross-sectional view taken along line VII-VII in FIG. 2.

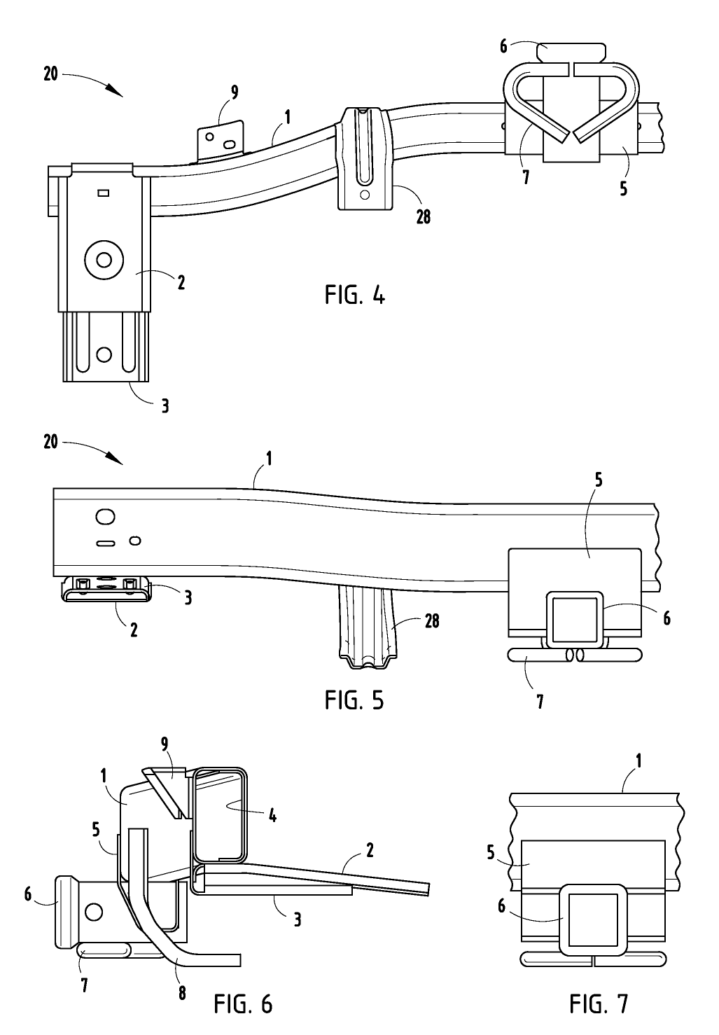

### DETAILED DESCRIPTION OF PREFERRED EMBODIMENTS

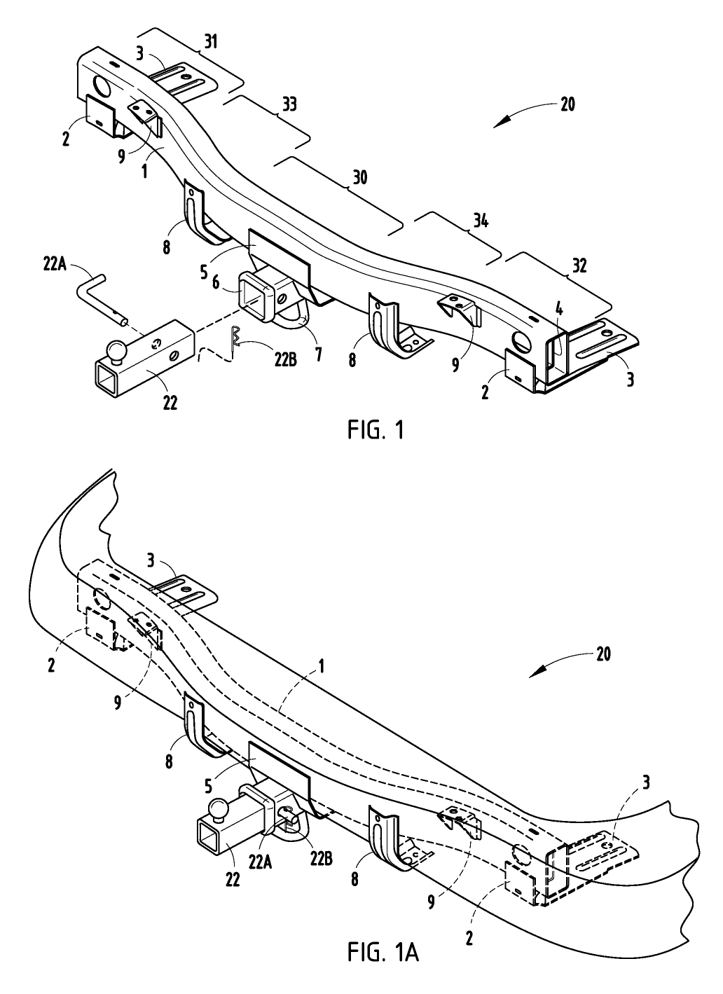

The bumper system 20 (FIGS. 1 and 1A) is configured to support a rear fascia 21 of a vehicle, including step-forming flat portions 21A and 21B of the fascia. The system 20 includes a rectangular tubular beam cross member 1 (also called a “bumper reinforcement beam”) made of high strength material in a way that minimizes weight and allows high-volume production of dimensionally accurate beam components, yet that provides an ability to underlie and support a bumper system that meets aerodynamic and styling considerations of vehicles . . . including hitch and towing functionality.

The tubular beam cross member 1 is supported on one end by lower and upper rail plates 2 and 3, and supported at its other end by lower and upper rail plates 2 and 23, with the plates 2, 3, 23 extending toward the vehicle in a forward direction for connection to a unibody frame of the vehicle. C-shaped reinforcements 4 (and 24) are inserted into and positioned within respective end sections 31 and 32 of the cross member 1. The reinforcements 4 and 24 matably engage inside top and bottom surfaces of the beam and extend therebetween, providing strength to the beam especially at beam mounting locations of the plates 2, 3, and 23. The illustrated reinforcements 4 and 24 are positioned partially in alignment with the plates 2, 3 and 23 and extend only a few inches inward, terminating well short of transition sections 33 and 34, . . . but it is noted that they can be extended as far inward as desired. The reinforcements 4 and 24 allow the material of the cross member 1 to be of a slightly thinner thickness, saving weight while at the same time maintaining beam strength and stiffness.

A hitch includes a receiver bracket 5, receiver tube 6, and chain loops 7 all welded together and to a center of the cross member 1. The receiver tube 6 is positioned under the center of the cross member and faces rearward for receiving a hitch bar 22 with ball, shear pin retainer 22A and lock pin 22B. L-shaped skid guard brackets 8 and 28 are attached to a rear face and bottom of the cross member 1. The skid guard brackets 8 and 28 are L-shaped and extend below the cross member 1 to a location substantially even with a bottom of the receiver tube 6 and chain loops 7. A bend in the L-shaped side guard brackets 8 and 28 is generously radiused, such that they will tend to skid onto an object that they engage . . . substantially preventing a rearward end of the receiver tube 6 from hooking on an object when the vehicle is moving rearward. Also, the brackets 8 and 28 extend forwardly sufficient to prevent a forward end of the receiver tube 6 from undesirably striking or hooking on an object as the vehicle moves in a forward direction. L-shaped support brackets 9 and 29 are welded to a rear face of the cross member 1 and extend upwardly, such that their upper leg provides an upper flat surface useful to support a portion of the bumper-system-covering fascia 21. They can also be used to support an energy absorber. The upper leg of the brackets 9 and 29 align with a top surface of the cross member and extend rearward. A top of the fascia 21 in the area of brackets 9 (and 29) is supported by the brackets 9 and 29 as well as by the end sections 31 and 32. The fascia 21 in the area of brackets 9 and 29 is relatively flat (and if desired has a rough non-slip top surface), such that it forms a suitable step at outer ends of the bumper system 20.

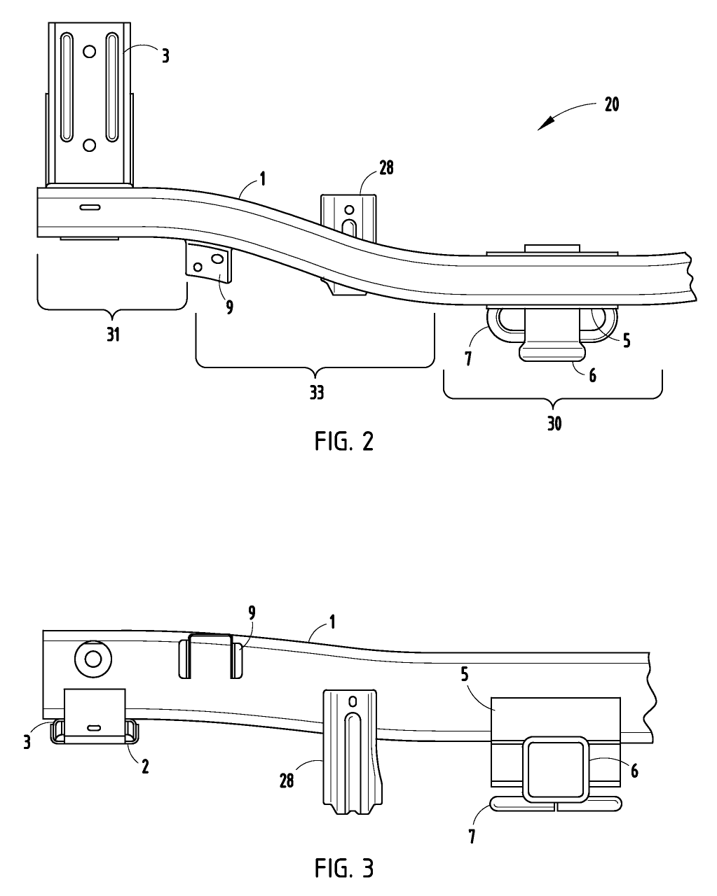

The cross member 1 is formed as a continuous tubular shape having a rectangular cross section with a vertical dimension almost twice its fore-aft depth dimension. The cross member 1 is preferably made by first roll-forming the sheet into a tubular shape, then welding the tubular shape to form a permanent tube, and then cutting the permanent tube into predetermined lengths suitable for use as bumper beams. The cross member 1 is then reformed to include a substantially linear center section 30, a pair of substantially linear end sections 31 and 32, and transition sections 33 and 34 that connect the end sections 31 and 32 to ends of the center section 30. The transition sections 33 and 34 include compound bends (i.e., bends deforming the beam in both vertical and horizontal directions) that position the center section 30 below and rearward of a line connecting the aligned end sections 31 and 32 (based on a vehicle-mounted position of the cross member 1). Notably, the compound bends are non-uniform along their length, with the amount of downward bending being slightly less than the amount of rearward bending (compare FIGS. 2-5). In other words, the horizontal and vertical bending define different vertical and horizontal dimensional extents.

In its offset position, the center section 30 extends parallel to the line between the end sections 31 and 32, but at a height which positions the hitch at a desired lower height and at a more rearward position relative to the vehicle. It also positions the license plate pocket (i.e., the location above the center section 30) at a desired height. This combination of structure and physical locations is very advantageous since it allows the entire cross member 1 to be made from a single tube, to be made with known high-volume manufacturing processes (i.e., low cycle times, durable tooling, tight part tolerances, tooling designed for high volume runs) suitable for high volume automobile assembly requirements, yet positions outer surfaces (i.e., top, bottom, front, and rear planar surfaces) of the cross member 1 at desired locations. It is noted that providing a rectangular bumper beam with compound bends is believed to provide surprising and unexpected results in terms of a high quality structure with reduced number of components, yet that meets functional and aesthetic requirements for design and styling criteria.

Notably, the top surfaces of the end sections 31 and 32 are relatively flat, such that they are useful for supporting fascia 21 . . . including providing support for a step on each of the end sections 31 and 32. Notably, the flat top wall of the cross member 1 always has a horizontal orientation (i.e., a transverse line drawn in a fore-aft direction anywhere on the beam 1 is always horizontally oriented), even in the transition sections 33 and 34.

It is contemplated that “reforming” of the continuous tubular shape to form the cross member 1 can be done in various ways, such as by stretch forming, stamping, and/or hydro-forming processes. A preferred technique is through the use of stretch forming, where the permanent (linear) tubular shape (previously cut to length) is placed in tension while its transition sections 33 and 34 are laterally reformed to place the center section 30 at a relative two-direction offset position relative to the end sections 31 and 32.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A bumper system comprising:
a tubular beam having a linear center section, opposing linear end sections, and compound-bent transition sections connecting the end sections to ends of the center section; the center section extending parallel the end sections but being positioned rearward and lower than the end sections when in a vehicle-mounted position by the transition sections.

2. The bumper system defined in claim 1, wherein the transition sections include compound bends that are non-uniform along their length.

3. The bumper system defined in claim 1, wherein the tubular beam has a rectangular cross section.

4. The bumper system defined in claim 1, wherein a line drawn transversely across a top wall of the tubular beam at any location along a length of the tubular beam has a horizontal orientation.

5. A bumper system comprising:
a rectangular tubular beam having a continuous cross-sectional shape and having a center section, opposing end sections, and transition sections connecting the end sections to ends of the center section; the transition sections being bent both vertically and horizontally to position the center section both rearward and downward from the end sections when in a vehicle-mounted position.

6. The bumper system defined in claim 5, wherein the transition sections are each bent to a greater extent in a horizontal direction than in a vertical direction.

7. A bumper system comprising:
a rectangular tubular beam having a continuous cross-sectional shape and having a center section and opposing end sections, the center section being positioned both rearward and downward from the end sections when in a vehicle-mounted position;
a hitch receiver attached to a bottom of the center section; and
a fascia covering the tubular beam and including end panels supported by the end sections to form steps on the bumper system.
